(19) United States
(12) Patent Application Publication
(10) Pub. No.: US 2008/0052708 A1
(43) Pub. Date: Feb. 28, 2008

(54) Data Processing System With A Plurality Of Subsystems And Method Thereof

(76) Inventor: Juhang Zhong, Beijing (CN)

Correspondence Address: Yang Xiumei C/o Zhong Juhang;Network Information Center, Beihang University, No.37 Xueyuan Road, Haidian District, Beinging, 100083, CN

(21) Appl. No.: 11/794,389

(22) PCT Filed: Dec. 29, 2005
(86) PCT No.: PCT/CN05/02356

§ 371 Date: Jun. 28, 2007

(30) Foreign Application Priority Data
Dec. 31, 2004 (CN) 200410102989.3

(51) Int. Cl. G06F 9/455; G06F 9/46

(52) U.S. Cl. 718/1; 718/105

(57) ABSTRACT

A method of virtual dividing of data processing system and a data processing system, for providing a plurality of physical or virtual sub data processing systems under the same data processing system interface, wherein each of sub data processing systems can achieve different applications; the security of different sub data processing systems are isolated each other, so that meet to different security requirements of applications for different requests; like TV channel, each of subsystems can be online switched; meanwhile, the invention provides the mainboards that can accomplish above-described functions, the switching devices, and the switching methods.

### FIELD OF INVENTION

This invention relates to data processing system and security technology, by integrating a plurality of physical or virtual sub data processing systems under the same data processing system interface, the data processing system (such as computer system), can meet to different security requirements of different tasks needed by user; and avoid the insecurity factors inflected between different tasks. Meanwhile, provide the protecting and verifying method for the firmware, such as basic input/output system (BIOS), which possible affect the security of data processing system,

### BACKGROUND OF THE INVENTION

With the information technology continuous development, more and more work can be done through data processing system (such as computer system) and network, this undoubtedly greatly accelerate the efficiency and convenience of the user.

However, just as the meaning of the name of data processing system, at the beginning of its creation, it was considered as data processing (such as the name of the computer from its rapid computing power), and the designer did not consider security factors, as a result, the issues of security of data processing system have become serious increasingly, especially in the field of electronic transactions, information confidentiality, individual privacy and so on, the losses due to security issues are getting bigger and bigger, and this “disaster” happens easier and easier, globalization trend has become more obvious.

Besides the security risk of data processing system itself, the operating habits and needs of users are also a kind of reasons leading to security problems, in most case, an unsafe website viewed by users leads to security vulnerability, and then their important accounts and passwords are disclosed, lead to economic loss at last, the cases like this are common occurance.

In other words, users have a variety of needs, the security requirements of the various needs are different, such as: the security requirements of viewing the daily news/entertainment are very low, but for electronic transactions, the security requirements are extra high, when these two tasks are in a same data processing system, the “vulnerability” of the low security required applications may “infect” the high security required applications.

Of course, there are some consideration for this in the existing data processing system, Microsoft Internet Explorer divides its security into high, medium and low level, to control different use environments, but it can not resolve the issues at all, this because: 1. the more and more IE itself loopholes; 2. the more and more Windows Operating System itself loopholes; 3. too high technical required to users. Just for those factors, people feel more and more insecure on network.

Another possible solution to the problem is to provide each kind of application an independent data processing system. Due to the high cost and low efficiency, it has no wide practical value obviously.

Meanwhile, although the damage against BIOS limits to CIH virus at present , and the CIH damages only BIOS, no spreading virus through BIOS yet, this is not to say that the virus can not be infected through BIOS, in fact, due to the high use of flash memory, by default, the most BIOSes of the motherboards, display cards, SCSI cards, network cards and so on have not been write protected and the programs in them have chance to be run in system, this provides a theoretical support for possible infecting and damaging a data processing system through the BIOS by the malicious programs, and this threat is often greater than that of the existing virus.

Even after CSS (Core System Software) BIOS or EFI (Extensible Firmware Interface) BIOS appears, the same security issues still exist, and because they also need the fundamental BIOS to load them, this, on the contrary, increase non-security chance.

### SUMMARY OF THE INVENTION

In order to solve said problems above, this invention provides a data processing system and a method of virtual dividing data processing system, used to divide a general data processing systems into a plurality of physical or virtual sub data processing systems, said subsystems can be used for different tasks, and can be on-line switched like TV “channel”, the mutual security isolation is made to different subsystems, so that avoid affecting each other; meanwhile, to ensure the basic security of data processing system, a new method of write protection and verifying for basic input/output system (BIOS) is also provided.

In addition, this invention also provides a switching device for virtual dividing data processing system and a mainboard used for the data processing system with a plurality of subsystems of said inventions

### DESCRIPTION OF THE INVENTION

A method of virtual dividing of data processing system, used to divide a data processing system into a plurality of virtual sub data processing systems, characterized in that:

Said multiple virtual sub data processing systems have their respective operating systems or applications, the kind of said operating systems or said applications may be the same, can also be different;

Said multiple virtual sub data processing systems share the resources of original data processing system by time-division;

Any time, at most, only one of the multiple virtual sub data processing systems, that share the same processor module, is in running, the virtual sub data processing system in the running state is the current “reality” data processing system based on the processor module in the eyes of users; said processor module may include a CPU, may also include a number of CPUs, each of said CPU may be mono-kernel, it may also be a multi-kernel.

User chooses the present operation of virtual subsystem by switching device.

The method of virtual dividing of data processing system of said invention, further comprises means for making security isolation to the auxiliary storage of different virtual subsystems, said means may be one of or some of or a combination of following means:

A. set up multiple physical independent auxiliary storage devices, make different virtual sub data processing systems use different physical independent auxiliary storage devices;

B. virtual dividing the storage space of single auxiliary storage, make different virtual sub data processing systems use the different virtual sub storages of said auxiliary storage;

C. make read or write protection to auxiliary storage space of virtual sub data processing system not in working state; for example, we can use this method if the virtual sub data processing systems share the same auxiliary storage device by different partitions;

D. make access deny to auxiliary storage devices that current running virtual sub data processing system does not need;

E. make read or write protection to auxiliary storage space that current running virtual sub data processing systems does not need;

F. other possible methods;

By isolating different auxiliary storage space, we can effectively control the possible transfer of insecurity between different virtual data processing systems.

Said multiple sub data processing systems can be online or offline switched, usually online switching is referring to the switching without shut down (or without turning off the power), and offline switching is referring to the switching with shut down (or with turning off the power).

A method of switching, for online switching between multiple virtual subsystems that share the same processor module, comprises the following steps:

a. user sends a Virtual Sub Data Processing System Swap request to switching device;

b. the switching device sends a System Swap Out signal to current running virtual sub data processing system;

c. current running virtual sub data processing system saves its work spot;

d. the switching device sets up the resources for next running virtual sub data processing system and sends out a System Swap In signal;

e. the next running virtual sub data processing system takes over the control, restores work spot saved previously, or performs boot or reboot or reset or user-defined boot. Said boot or reboot is applicable to the first System Swap In of subsystems, or there is no work spot saved previously. Said user-defined boot is referring to that the user specifies the way of establishment of work state after System Swap.

A method of saving/restoring work spot, characterized in that:

Said method of saving work spot comprises the following steps:

A. OS(Operating System) sends a Save Work Spot notice to all running tasks;

B. the running tasks clean up their work spaces and resources;

C. OS cleans up its work space(s) and resource(s);

D. save the basic system information which is enough to reconstruct current working environment;

E. save the states of all devices used by the OS;

Said method of restoring work spot comprises the following steps:

A. load the states of all devices used by the OS at that time, that saved in “saving work spot” previously, and set up those device states;

B. load all the basic system information which is enough to reconstruct current working environment, that saved in “saving work spot” previously, and reconstruct the working environment of that time;

C. OS(Operating System) restores its work space and resources;

D. OS sends a Restore Work Spot notice to all running tasks;

E. the running tasks restore their work spaces and resources;

Said method of offline switching between virtual sub data processing systems comprises the following steps:

A. power off the data processing system;

B. switch to new virtual sub data-processing system by switching device;

C. restart the data processing system;

Each of the methods, for virtual dividing data processing system, of said invention above, further comprises means of establishment of working state of virtual sub data processing system, said means may be one of or some of following means:

A. resume, is referring to restoring the work spot from any one of work spots saved before, this also means that virtual sub data processing system can save a work spot at any time;

B. reboot/restart, is referring to restarting virtual sub data processing system;

C. original reset, is referring to resetting virtual sub data processing system to the most primitive state and starting it;

D. install/reinstall, is referring to installing or re-installing virtual sub data processing system and starting it;

Said work state can be created when current running virtual sub data processing system take over the control, can also be designated by user when virtual sub data processing system is being switched, said designation is about the virtual sub data processing system swapped in.

A data processing system, characterized by comprising: at least two or more sub data processing systems.

Said processor module(s) of multiple sub data-processing systems is (are) in the same physical casing; Any one of said sub data processing systems may be a sub data processing system with independent physical processor module, or may be a virtual sub data processing system sharing processor module;

Said processor module has one CPU or a plurality of CPUs, each said CPU can be mono-kernel or multi-kernel.

All or part of said sub data processing systems share at least one display device, or at least one input device;

The data processing system of said invention, characterized by further comprising: a switching device (600), is used for selecting current sub data processing system for user to use or to operate;

Said switching can be offline switching with shut off (or with turning off the power) or online switching without shut off (or without turning off the power);

By using said switching device, said sub data processing systems can maximize the sharing of input/output equipment, such as the display device, keyboard, mouse and so on, and more, this also can let user in a relatively consistent operating environment for the conduct of the operation, that is, to save the cost and simplify the operation.

The data processing system of said invention, characterized by comprising: the fixed bootable auxiliary storages of said different data processing systems are different auxiliary storages or different virtual sub storages of same auxiliary storage; said “fixed bootable auxiliary storage” is referring to the auxiliary storage, non-temporary, relatively fixed for a period of time, for system booting under normal work environment, usually is harddisk or electronic disk.

The data processing system of said invention, characterized in that: the firmware device, that is re-programmable and can get chance to run in the processor module, of said sub data processing system is all or part write protected, or the content of said firmware itself can be non-juggled checked. Said firmware can be seen normally in basic input output system (BIOS) or is a group of service procedures for the operation of a hardware between the hardware and the Operating System.

A switching device (601), for supporting the virtual dividing of data processing system, characterized by comprising:

An input interface of control (701), for receiving signal of selecting from user, the property of said interface is similar to that of TV Channel interface, and the content of selecting is relatively singleness, so the interface can be mechanical or electronic, it can also be wired or wireless, the signal can be encoded signal or direct selecting signal;

A control unit (700), for controlling the switching between different virtual sub data processing systems according to the signal of user's selection; as a relatively simple function, this module can be implemented by logic circuits, micro-controller or discrete components/IC;

An interface to host (703), for communicating with the data processing system, the communication between control unit (700) and host is very limited and simple, such as: sending “System Swap Out”, receiving “System Swap Out Complete”, sending “System Swap In”, so the interface can be any kind of generic or special interface, for example, ISA, PCI, USB, RS232, Parallel port, 1394 interface, I2C, and other various generic or special interfaces;

An output interface of control (702), for providing required selecting signals to other devices in the switching process of virtual sub data processing systems, for example, the signal for switching multiple harddisks, said signals are created by control unit according to user's selecting signals, the interface can be mechanical or electronic, it can be wired or wireless, the signal can be encoded signal or direct selecting signal;

Said control unit (700) is connected with said input interface of control (701), said output interface of control (702) and said interface to host (703);

Said input interface of control (701), said output interface of control(702) and said interface to host (703) may partially or wholly share the same interface bus, may also use different interfaces respectively, such as the wider use of I2C bus in home appliances can be applied here;

Said switching device (601) can be integrated on the motherboard, thereby said motherboard gets the capability of virtual dividing, said motherboard with the capability of virtual dividing means that the data processing system based on said motherboard can be virtual divided into a plurality of sub data processing systems.

A multi-unit motherboard, comprising at least two or more physical sub-motherboard modules, each of said sub-motherboard modules can he used for building a physical data processing system, each of said sub-motherboards can be general motherboard, it can also be a sub-motherboard with capability of virtual dividing, said multi-unit motherboard is used to build a data-processing system with multiple sub data processing systems, said motherboard characterized by comprising: A selecting device (602), said selecting device (602) is used to support selecting/switching of sub-systems, said selecting device (602) comprising:

An input interface of control (711), for receiving the selecting signals from user, the interface can be mechanical or electronic, it can be wired or wireless, the signal can be encoded signal or direct selecting signal;

A switching unit for sharing interface (710), for switching the interface(s), that share the same device or same interface port, according to the signal of user's selection, said switched interface can be the interface provided by the motherboard, it can also be the interface provided by the add-on card on the motherboard, because said switching is based on the physical signal of channel selecting and switching, thus said interface can be any kind of wired or wireless interface.

Said switching unit for sharing interface has at least one shared display output interface or one shared input device interface;

The multi-unit mainboard of said invention, characterized by further comprising: an output interface of control (712), used to provide selecting signals needed by other sub mainboard unit or equipment in the process of switching subsystems, for example, if the sub mainboards have virtual dividing function, they will need the selecting signals; The interface can be machinery, it can also be electronic, it can be wired, it can also be the wireless, the signal can be encoded signal, it can also be a direct selecting signal;

Said output interface of control (712) and said input interface of control (711) can share same interface bus, can also use different interface;

The interfaces switched by said switch unit for sharing interface (710) can be configured or adjusted by user, the user can decide which interface need not be switched (no sharing), the configuration can be done through BIOS or jumper switch.

A security control method of basic input/output system (BIOS), comprising the means of write protection, said write protection characterized by comprising:

a. step of dividing said BIOS space by function;

b. step of setting up write protection devices to functional space of said BIOS respectively;

Said write protection devices must be configured by user in local or must be configured under authorization of user

In general, the space of BIOS may be divided into multiple blocks, such as the BIOS of current motherboard may have program block and ESCD data block, and the program block also has BOOT (8K or 16K) block and the other program blocks, the current BIOS write protection switch is against all space of the BIOS, once the switch was made to enable write protection, ESCD block will not be able to read and write, even computer can't get the type of the BIOS chip, this kind of write protection sacrifices the performance of computer for the price.

The write protection features (such as the write protection to BOOT block) in a BIOS chip are controlled by a computer chip group, in other words, this write protection is to prevent mis-operation or signal interference, rather than to prevent the virus.

To set up different write protect switches for different blocks, according to the method of said invention, will solve said problem. These write protection switches can be configured only by authorization of user.

A security control method of basic input/output system (BIOS), comprising the means of write protection, characterized by further comprising the means for checking the information of BIOS, said means of checking comprises:

a. step of setting up interface for checking said BIOS information;

b. step of selecting space of checking;

c. step of checking said selected space through said checking interface;

d. step of comparing the checking result with the same version of a security or clean BIOS;

Any algorithm can be used for checking, such as CRC8/16/32/64, MD5, SHA256/384/512 and so on, or even fully read all the contents and compare them directly.

The method of said invention for checking BIOS information, being done before the BIOS itself is loaded, in this way can avoid computer being controlled by malicious program in virus-infected BIOS, which may affect the checking result. If being checked after the BIOS was loaded, the virus in BIOS can restore the original contents of BIOS and re-infect it before shut off, and then the result of checking is meaningless.

Beneficial Effects

The methods and systems of said invention, provide different operating environment for different tasks, thus to achieve the control of different security requirements, security isolation between different tasks can be done better, thus able to avoid unsafe factors to be infected between different applications, the security is better protected, this have very widespread practical significance.

Moreover, the computer system can be used as home appliances, besides the original function and use habits, we can also use it like home appliances (such as television), switching different tasks just like switching TV channels, we can also implement the function like picture-in-picture (PIP) in lower cost.

The security control methods based on basic input/output system (BIOS) of computer systems and its various components, considering current security circumstance, provide means to control possible path of future attack and damage, this will further ensuring the computer system's security.

By selecting/switching device (601), we can ameliorate existing mainboard, so that it can support the virtual dividing of data systems. The multi-unit mainboard provides user an implement scheme of integrated and multi-subsystems based data processing system.

### BRIEF DESCRIPTION OF THE DRAWINGS

FIG. 1, a data processing system with a plurality of physical sub data processing systems and a plurality of virtual sub data processing systems. In this figure, 201 is the physical sub data processing system in computer case (200), has a separate auxiliary storage unit(harddisk) and processor module (located on the mainboard) 202 is the virtual sub data processing system in computer case (200), shares the processor module on physical mainboard (80) and multiple virtual sub-harddisks divided from physical harddisk (81); multiple sub data processing systems share display (100), keyboard (300), CD-ROM (10), mouse (20) and modem (30), in whole or in part, according to their needs, by switching device (600)

FIG. 2, a data processing system with a physical sub data processing system and a plurality of virtual sub data processing systems. The difference between this figure and FIG. 1 is the number of physical sub data processing system, multiple in FIG. 1, one in this figure, the others basically the same.

FIG. 3, a data processing system with four virtual sub data processing systems. The difference between this figure and FIG. 2 is, in this figure, all the four subsystems are virtual sub data processing systems, without physical sub data processing system, four virtual sub data processing systems share the processor module on the physical mainboard (80), but with the respective independent harddisks;

FIG. 4, a data processing system with a plurality of physical sub data processing systems. The difference between this figure and FIG. 1 is, in this figure, all the four subsystems are physical sub data processing systems, without virtual sub data processing system, four physical sub data processing systems have respective independent main board and harddisk.

(In above figures, dashed line means said virtual, no repeat description for the same part)

FIG. 5, structure diagram of selecting/switching device. In this figure, 701 is the input interface of control, 702 is the output interface of control, 700 is the control unit, 703 is the interface to host;

FIG. 6, structure diagram of selecting/switching device (602) of multi-unit motherboard. In this figure, 711 is the input interface of control, 712 is the output interface of control, 710 is the switching unit for sharing interface, 602 is said selecting/switching device;

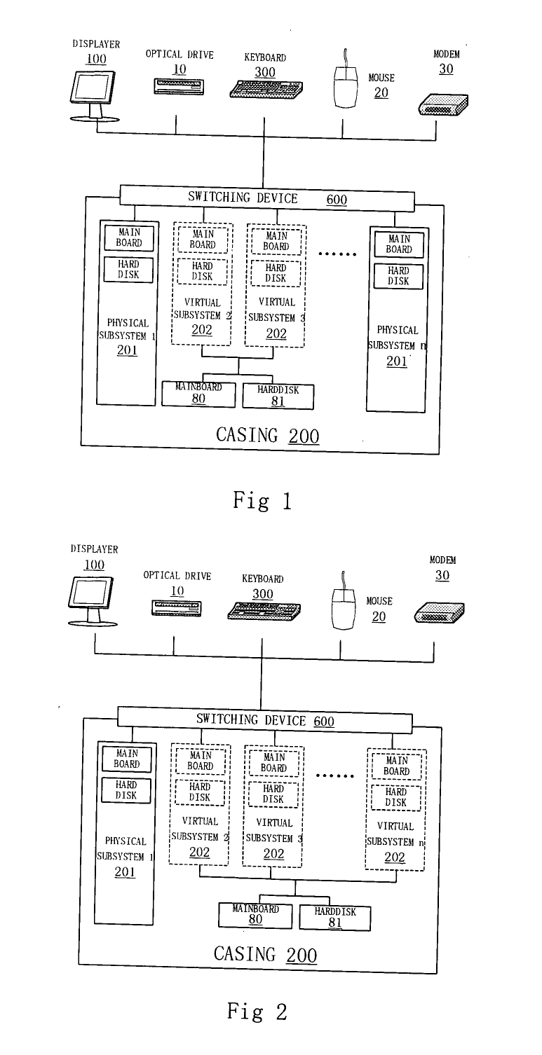

101 is a shared interface of display, 40 is the display interfaces from sub-units of said mainboard;

301 is a shared interface of keyboard, 50 is the keyboard interfaces from sub-units of said mainboard;

121 is a shared interface port of USB, 60 is the USB interface ports from sub-units of said mainboard;

Now with the implementation to further explain said invention.

### DETAILED DESCRIPTION OF SPECIFIC EMBODIMENTS

A method of virtual dividing data processing system can be implemented as:

According to the purposes of data processing system, to divide it into a plurality of virtual sub data processing systems, each of data processing systems for the completion of a purpose, for example, a data processing system used for work, entertainment, Email and finance, can be divided into four virtual sub data processing systems, respectively called as the working channel, the news entertainment channel, Email channel and the finance channel;

Perform switching between different channels by setting up a channel-selecting device (virtual sub data processing system switching device).

Four channels share all hardware, of course needed by the channel, of the originally data processing system but the harddisk, such as the motherboard, memory, video card, network card, sound card, monitor, keyboard, mouse, CD-ROM, modem, etc.;

The harddisk can be set up by the following means of any one or more of them or any combination:

1. Use a harddisk with virtual dividing equipment (the four virtual sub hard disks are needed in said case), each virtual sub harddisk for the use of one channel, the selecting device of virtual sub harddisks is controlled by the channel-selecting device of the data processing system.

2. To use more than one physical harddisks, each channel use a physical hard disk, the multiple harddisks are switched through harddisk-switching device controlled by the channel-selecting device (switching device) of the data processing system;

3. Use the same harddisk, set up four different partitions, each partition for the use of one channel. Said method needs the support of BIOS, BIOS reads the channel number from channel-selecting device of the data processing system, and decides to boot from which partition (may hide or un-hide the other partitions according to the requirements), the security of said means is lower than the security of means 1 and 2;

4. Other methods, such as: use different spaces of the same hard disk (need BIOS support), use the same partition of the same hard disk and use different bootstrap, share part of the same partition of the harddisk.

The needed BIOS support can be made by modifying the BIOS.

For said implementation, in order to provide the best security and best performance ratio, it is recommended to use harddisk with virtual dividing device or a plurality of electronic disks.

For different channels, the following means can be used in any one or more of them to establish a work state:

1. Install/Reinstall, is referring to re-installing of a channel and starting the channel(the first installation included), every time alter the installation, the first basic state authorized by user we define it as original installation state; said basic state is the basic condition of software system environment to satisfy said channel;

2. Original Reset, is referring to resetting a channel to the original installation state and starting it, the original installation state may be the first basic state authorized by user after an installation, it may also be a direct authorized original system state (such as: the bank can provide user the professional trading system by electronic harddisk, in this time, the system in the electronic harddisk is the original installation state for user)

3. Reboot/Restart, is referring to restarting a certain channel;

4. Resume, is referring to restoring the work spot from any work spots saved before, the work spot is the entire working environment at a certain time saved by user or saved in System Swap.

Of course, besides any means above, we can also change the hardware/software environment and working state of a channel through installing/deleting or configuring.

Said original reset, may be understood and implemented referring to software GHOST or referring to hard reset of handheld device.

The switching device of the method of said invention, for connecting the current channel with the entire hardware/software environments needed to the channel, and setting current user interface with corresponding channel. Said switching can be made by the use of machinery, electronics, software sign or other every possible way.

Offline switching method is very simple, can be completed through shutting down, switching the channel to new channel and restarting. The method is easy, but need a longer time to switch on/off each time, and must re-build the work spot each time, not suitable for frequent “channel” switching.

Online switching is more complicated, in addition to hardware switching, saving the work spot of current channel and restoring the work spot of new channel are extra needed. In this regard, we can refer to the principle of the CPU interrupt, think the entire data processing system as a huge virtual CPU, and all resources of the data processing system, including the real CPU, memory, motherboard, and all related equipment states, are regarded as the attributes of this huge virtual CPU, as long as the attributes of this huge virtual CPU are saved, the work spot is saved, load all the attributes of this huge virtual CPU from the external storage, means that the work spot is restored. This may refer to the art of game-modifying software (DOS version, such as GameMaster or GameBaster), and the art of debugging software (such as softice).

Another way is to use the Operating System, implementing the function of saving/restoring work in Operating System.

Following as a possible optimization steps of saving work spot:

A. Operating System sends “channel swap out” notice to all current running tasks;

B. The current running tasks clean up their work spaces and resources, and minimize them;

C. Operating System releases all devices and memory space that itself does not need;

D. If there is the page-swap file, then flush it;

E. save the entire minimum system information required for re-constructing the current working environment;

F. save the states of all devices it used;

Following as other corresponding steps of restoring work spot:

A. load the states of all used devices saved in “saving work spot” previously;

B. load all the minimum required information and software system for re-constructing current working environment saved in “saving work spot” previously;

C. reconstruct the current working environment;

D. send “channel swap in” notice to all current running tasks;

E. the current running tasks resume their work spaces and resources, and make them normalized;

The communications between channel-switching device and the current channel (a sub data processing system) may be done by serial port or through other generic/special interface, a interrupt method or a polling method can be used, the combination of the use of interrupt and polling is recommended.

When the channel switching device got the signal of the completion of “saving work spot” issued by current channel, will be switching to a new channel (hardware and operating interface), and set a sign of “system swap in”, and then reset the system, the system BIOS take over the control, when detected a sign of “system swap in”, will skip the hardware detection, direct or indirect enter “restoring work spot” service procedure, the previous working state of new channel is resumed (to read “system swap in” sign, the BIOS need to be correlatively modified).

In general, the first sector of a boot partition is the boot sector, for booting the common system, the sector 2nd-63 are blank sectors, general for reserve, we can set the second sector as boot sector for “channel swap in”, when system(channel) swap in, the BIOS directly boot from the second sector. Of course, it can also be decided between a common boot and a “system(channel) swap in” boot by a judging in normal first sector.

In said implementation, for the entertainment channel, because the security requirements is relatively low, we use a Windows XP and an IE;

For Email channel, the security is important, we use a Windows2000 and a Foxmail, and use a special firewall, the Foxmail is only allowed to use specific ports, meanwhile, close all unnecessary controls and functions of the windows2000, a FireFox browser (in safe mode) can be used when need.

For finance channel, security is very important, we use a trading system on an customized Linux, The trading system would only be used to support electronic transactions, on-line banking and so on, include very strong network security measures, does not provide any other functions (for example, can not be used to view the news and entertainment, etc.);

For work channel, due to the confidentiality of information, the Internet is prohibited, we can uninstall network driver of the Operating System of said work environment, and prohibit all the network functions;

The security isolation of said implementation can be controlled by complete isolating the direct visit paths of software between different channels, the specific means is : to use the harddisk with virtual dividing function or multiple electronic harddisks, and make different channel can only visit its own sub-harddisk or electronic harddisk, does not destroy or affect the harddisks or electronic harddisks of other channels; make checking to the BIOS of relevant parts of data processing system, protect all program blocks of the BIOS after no problem found. The CMOS of system and the ESCD of BIOS is special data block, and can not be used for the propagation of virus, of course, user can also choose to write protection to the ESCD block.

Using the methods of said invention, we can get four virtual sub data processing systems, which used for four applications with different security requirements, such as work, entertainment, Email and finance, from a data processing system, and it can follow the example of the use of television as the use of computer, switching between said tasks freely, for example: tired in working, want to have a entertainment, direct switch to entertainment channel, saw good entertainment news, want to tell friends, then switch to Email channel directly, send email, and then we can switch to finance channel and look up own bank account, and then switch back to the work channel, continue to work, at this time, the working state of work channel is the same with the state of the work channel left previously. Channel switching is the same with the use of television, which can be mechanical channel switching equipment, or can also be electronic or remote control. Using computer with the methods of said invention is convenient and safe, has great social value.

The security control method of the basic input/output system (BIOS) of said invention has been applied in the implementing of the method of virtual dividing data processing system above, it can be implemented as: said checking interface is leaded to casing or front panel by interface wires, use other equipment to perform checking, the any content and type of BIOS chip can be accessed through said interface. Of course, said checking interface may be a dedicated device interface to certain equipment, the checking can be done through said equipment, for example, the system BIOS of motherboard. And more the BIOS and the CPU of motherboard can be used for checking other BIOS, such as SCSI card or network card, through bus interface.

The protection method of the different data block of said write protection method, is completed by comparing the write addresses, a writing to the BIOS is permitted or not, depending on said comparison result and the write protection switch of the address block that said address belong to, said comparing can be implemented by logic circuits, the range of definition of address block, if necessary, can be configured and modified.

The online switching method, for online switching between multiple virtual sub data processing systems that share the same processor module, can be implemented as, the switching request of user can be sent through mechanical channel switch or electronic remote switch, the switching device receives the switching request from user, sends “system swap out” signal to the current sub data processing system, said signal uses interrupt-driven recommended, the current sub data processing system receives the interrupt signal, send a notice to its Operating System, the OS calls routine of saving work spot, when finish, sends back a “system swap out complete” signal to switching device, the current subsystem swap out successfully.

If the switching device did not receive the said signal in defined time frame, then re-sends the “System Swap Out” signal, in the defined number of failures, according to the advance setting, make decision of mandatory switching or maintaining the current status.

After the completion of swap out(or user chooses mandatory switching after the failure), the switching device switches the resources needed by the new sub data processing system, mainly switches the harddisk storage module and sets some system settings (such as disable certain hardware or set certain hardware to certain specific state etc.), and then switching device sets “system swap in” signal (it's recommended that said signal is implemented as signal level set in the switching device), Through system reset (warm start), give the control to the system BIOS.

The BIOS takes over the control, examines the “System Swap In” signal set by the switching device, when detects the sign of System Swap In signal, will skip the hardware test, direct or indirect enter the service procedure of restoring work spot, the previous working state of new channel is restored.

In general, the first sector of a boot partition is the boot sector, for booting the common system, the sector 2nd-63 are blank sectors, general for reserve, we can set the second sector as boot sector for “channel swap in”, when system(channel) swap in, the BIOS directly boot from the second sector.

Of course, it can also be decided between a common boot and a “system (channel) swap in” boot by judgment in normal first sector.

The new sub data processing system begin to run when the restoring work spot is completed, it may send a “System Swap In Complete” signal to the switching device by choice, this step is just to provide a complete response, is not necessary.

Said process need the BIOS support, which can be done by modifying the BIOS.

The communication between the switching device and the data processing system can be implemented through any kind of interfaces.

The method of saving/restoring work spot can be implemented as, set up a group of system functions in Operating System level, that is, the function of saving work spot and the function of restoring work spot, wherein the call to function of saving work spot is activated by the “System Swap Out” signal issued by the switching device, when the call is completed, the Operating System may reply the switching device a “System Swap Out Complete” signal, then it stops itself or stands in the circle of wait; the call to function of restoring work spot is done by boot program under “System Swap In” signal, when the call is completed, the Operating System may send switching device a “System Swap In Complete” signal.

FIG. 2 illustrates the best implementation of the data processing system of this invention, the data processing system of said best implementation includes a physical sub data processing system and a plurality of virtual sub data processing systems, in other words, the number of virtual sub data processing systems of said implementation is variable, this depends on the minimum between the maximum number of virtual sub-harddisks provided by the harddisk with virtual dividing function used by system and the number of channel-selecting provided by switching device (600) of said implementation −1. This design is intended to meet the actual needs.

Said implementation includes two mainboards (each has a processor module) and the corresponding add-on cards, one of the mainboards is for physical sub data processing system, another is for the sharing of multiple virtual sub data processing systems, the physical sub data processing system can use any kind of auxiliary storage devices (harddisk A), virtual sub data processing system use the harddisk (81) (harddisk B) with the virtual dividing function. Choose current popular strong performance mainboard (mainboard A) for physical sub data processing system, and choose the mainboard (mainboard B) of principal type of security for virtual sub data processing system, for example, VIA's Nano-ITX mainboard, only 12 cm×12 cm in size, providing a number of safety measures in hardware level, and with low power consume, even two motherboards, can also use an ordinary power to support.

The physical sub data processing system for the use of the tasks with no or low security requirements such as daily gaming, browsing and amusing, the virtual sub data processing systems for the use of the high security required tasks, each virtual sub data processing system for a task or for a kind of tasks, such as : emails, credit cards, bank cards, payment cards, electronic transactions, member services, and even, different banking services can be done through different virtual sub data processing systems, in this way, do not lead to damage to all accounts even in any negligence, so it has a high level of security. Because the virtual sub data processing systems can be expanded at any time and make it easier for the user to set up for the new requirements.

Because there are two mainboards, they can work simultaneously, which means that, when the physical sub data processing system is downloading a relatively large movies, user can switch to a virtual sub data processing system to check email or access bank accounts. This has a same effect with the picture-in-picture (PIP) function of the television.

All sub data processing systems share the monitor, keyboard and mouse;

The CD-ROM, modem and other equipments are decided by needed, for the CD-ROM drive generally do not need to be used simultaneously, it can be shared; if the modem work in routing mode, the two mainboard can access it through a Ethernet Switch, if it is dial-up connecting, user will need to decide whether it is necessary to share;

As for the Parallel/Serial/USB interfaces of the two mainboards, may decide whether to allow the switching device (600) to switch them to the ports of the panel according to the requirement.

The software system is set up according to the requirement, it can be a common system, it can also be a dedicated system.

The switching device (600) uses the form below for equipments switching:

| | subsystem 1 | subsystem 2 | subsystem 3 | . . . | subsystem n |
|---|---|---|---|---|---|
| Displayer | −>mainboard A | −>mainboard B | −> mainboard B | . . . | −> mainboard B |
| Keyboard | −>mainboard A | −>mainboard B | −> mainboard B | . . . | −> mainboard B |
| Mouse | −>mainboard A | −>mainboard B | −> mainboard B | . . . | −> mainboard B |
| Optical drive | −>mainboard A | −>mainboard B | −> mainboard B | . . . | −> mainboard B |
| Shared USB port | −>mainboard A | −>mainboard B | −> mainboard B | . . . | −> mainboard B |
| Printer | −>mainboard A | −>mainboard B | −> mainboard B | . . . | −> mainboard B |
| Modem | user decide | user decide | user decide | . . . | user decide |
| Harddisk A | −>mainboard A | — | — | . . . | — |
| Harddisk B-1 | — | −>mainboard B | — | . . . | — |
| Harddisk B-2 | — | — | −>mainboard B | . . . | |
| Harddisk B-(n − 1) | — | — | — | . . . | −>mainboard B |
| Working state | No Change | Swap in/out | Swap in/out | Swap in/out | Swap in/out |

The switching device (600) can use mechanical or electronic means to switch said needed equipments. The basic form of the switching between equipments is 1 chosen from 2 (eg: for the monitor) or 1 chosen from N (eg: for the harddisk with virtual dividing function), the difference is only the number of different wire cores of different interfaces, these are simple technologies.

For the online switching between the virtual sub data processing systems that share the same processor module, the saving work spot and the restoring work spot are needed, and can be done according to the steps of the methods of dividing data processing system of said inventions, the control module of said needed switching device can be implemented by some circuits, logic circuits or micro-controller.

For the online switching between the virtual sub data processing systems that share the different processor modules, the online switching between the virtual sub data processing system and the physical sub data processing system and the online switching between the physical sub data processing systems, because the subsystems of swap in/swap out are working in different physical mainboards and different physical hard disks, generally no need to do saving/restoring work spot.

But for a situation, that is, when the new subsystem of swap in is a virtual sub data processing system, and the new virtual sub data processing system is not the current running virtual sub data processing system that share the same physical mainboard(the processor module included), at this time, the saving work spot and the restoring work spot are needed, the only difference is that the object of saving work spot is not the subsystem of swap out, but the current running virtual sub data processing system on the physical mainboard that the new virtual sub data processing system located on.

In another implementation, we can make virtual dividing to the physical sub data processing system 1 (201) of said implementation above, thus forming a data processing system with two groups of virtual sub data processing systems. Clearly, it can be done by replacing the harddisk of the physical sub data processing system 1 with a harddisk with virtual dividing function, and re-designing(defining) the switching device.

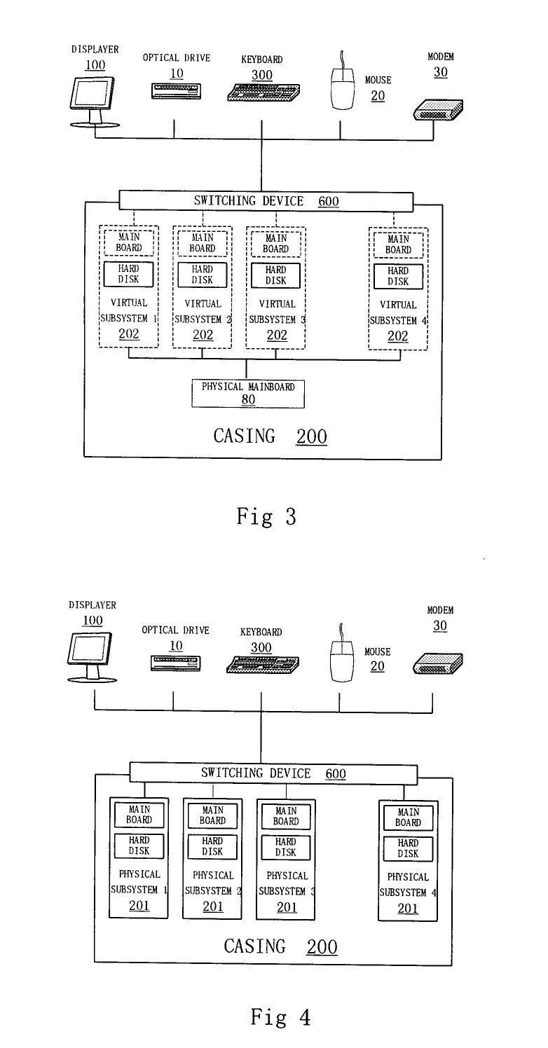

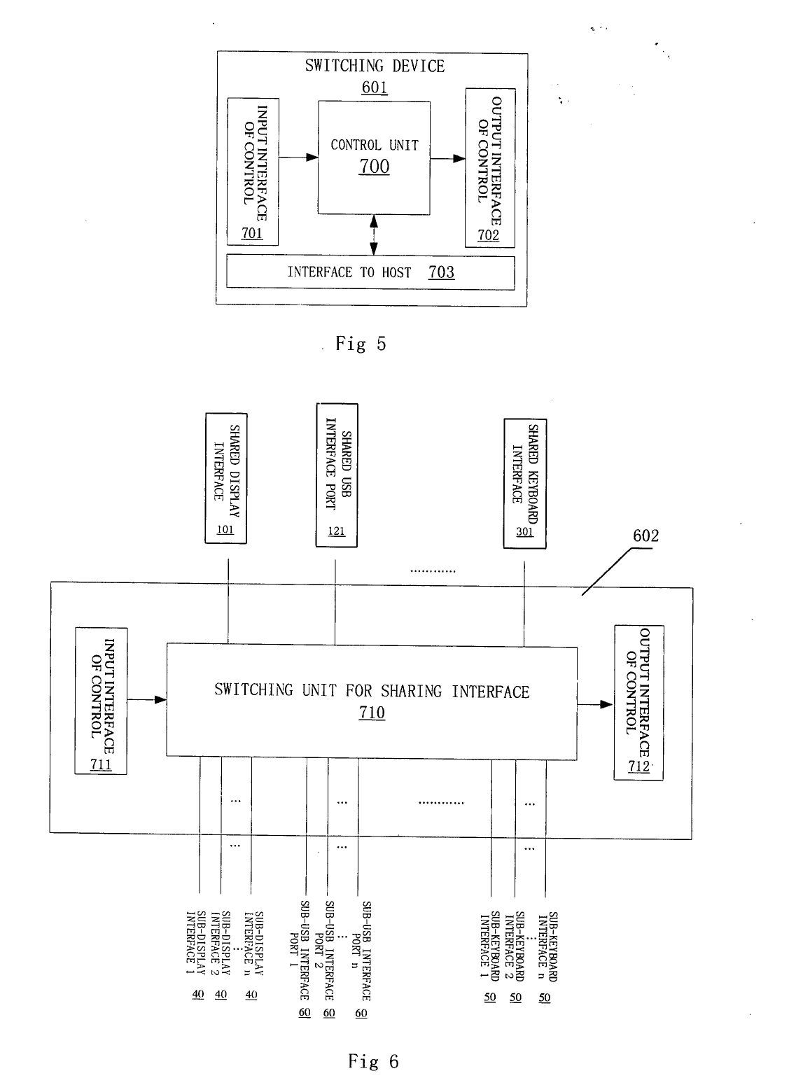

FIG. 3 illustrates the implementation of a data processing system with four sub data processing systems that are all virtual data processing systems, however, each virtual sub data processing system using separate electronic harddisk, cooperating with card-like electronic harddisk selecting device(may be included in the switching device), for the use of the dedicated system with high security required, because the card-like electronic harddisk can be replaced at any time, even if only four sub data systems, can be extended to numerous practical applications by the replacement of the electronic harddisk at any time.

FIG. 4 illustrates the implementation of a data processing system with four sub data processing systems that are all physical data processing systems, for the special needs of many parallel tasks running occasions.

When the data processing system of said implementations above is going to shutdown, it needs to shut down all of the current running subsystems in turn, and then the total power supply may be turned off. It can be implemented as:

1. switch to each of the current running subsystems and turn off it, the final turn off the total power;

2. send a “power off” signal to the switching device through any one of the subsystems, the switching device then forwards the signal to all of the current running subsystems;

For the startup, it needs to notice that, for the non-PnP mouse and keyboard, if multiple physical subsystems booting at same time, and system sharing only a mouse and a keyboard, will definitely lead to some subsystems missing the detection of them, the result is the mouse and the keyboard can not be used, the problem can be solved as:

1. Use a PnP mouse and keyboard, such as USB mouse and keyboard;

2. Set the startup operation only for the current subsystem of user's selection, that is to say, the startup for a subsystem is made only when need to use it, otherwise without making the startup, that is a solution to the above problem, but also saves energy;

An example of the switching device (601) of said invention can be implemented as, design a PCI interface card, that is, the interface to host (703) is the PCI interface, the host and the selecting/switching devices (601) can communicate with each other through the PCI interface, the input interface of control use the selecting signal, the switching device of said example support 8 “channels”, and consequently, the signal can be set up through a band switch of 1 chosen from 8 (located on user's case panel, and is equivalent to the television channel tune), the band switch is connected to the input interface of control(701) through nine wires(including a ground wire), low level is the active.

The control unit (700) is implemented by using a simple 8-bits microcontroller, for example, 89C51 and the corresponding external circuit. Specific processes are described in detail in methods of this invention, not going to repeat here.

The output interface of control (702) in the example is designed as user-definable, this is, user can choose output mode between encoding signal and selecting signal, for selecting signal, user can also define the active state between low-level and high-level, so that may be suitable for more equipment selecting.

For the setting and redefining of output interface of control (702), can be implemented by the micro-controller in the control unit (700).

Another example of switching devices (601) can be implemented by using a USB interface to communicate with the host, and the input interface of control (701) use infrared interface, corresponding with user's remote control operation. The input interface of control (701) of this example may also be designed to support both infrared interface and coding interface, the former for the use of remote control, the latter for the use of digital-key-tune equipment(located on the panel).

The BIOS support needed by the two examples above, can be implemented by adding the standard BIOS module and calling interface to the BIOS of mainboard needed by user.

The third example of selecting/switching device(601) is a mainboard with the switching device (601), that is, said device is integrated to the mainboard directly, the interface to host (703) of said example is implemented by using inner dedicated interface, provide the connector of the input interface of control (701) and the output interface of control (702). As integrated on the motherboard, so the options can be directly configured in the BIOS and it can direct support the virtual dividing function. The whole module is implemented using specific integrated circuit. The input interface of control (701) and the output interface of control (702) of said example are recommended to be implemented by sharing the same I2C Bus and using encoded transmission of information (signal).

Perhaps in the future, the interface standard for virtual dividing can be defined.

The best implementation of the multi-unit motherboard is a mainboard with two sub mainboard modules, one of the sub mainboard modules with support for virtual dividing function(sub mainboard B), said sub mainboard can be made by the VIA Nano-ITX mainboard with a switching device (601) integrated. Another sub mainboard may be the prevailing strong performance mainboard (sub mainboard A).

The multi-unit mainboard of said implementation is used for providing integrated hardware support to the data processing system shown in FIG. 2.

The input interface of control (711) of the selecting/switching device (602) for receiving “channel” selecting signal from the user, the switching unit for sharing interface (710) is used to switch the shared devices or interfaces between sub-mainboard A and sub-mainboard B (some related descriptions are in the implementation of the FIG. 2), the output interface of control (712) is connected to the input interface of control (701) of the selecting/switching device (601) on sub-mainboard B, the output interface of control (702) of selecting/switching device (601) is connected to the input of selecting device of harddisk required by sub-mainboard B.

Because the selecting/switching device (601) and the selecting/switching device (602) at the same large motherboard, therefore, in actual, they can be merged to the same device, or even with the use of same dedicated chip.

In said implementation, we define the physical sub data processing system created by the sub-mainboard A as 1#, define the virtual sub data processing systems created by the sub-mainboard B as 2# . . . n#, the user's selection of 1# . . . N# from the input interface of control (711) to enter, for the selection signal of 2# . . . N#, besides switching the shared devices and interfaces to the sub-mainboard B, the switching unit for sharing interface (710) also needs to transfer the signal of 2# . . . n# to the input interface of control (701) of the switching device (601) through the output interface of control (712), at this time, the 2# . . . n# is equivalent to 1# . . . (N-1)# of virtual sub data processing systems in sub-mainboard B, at this time, the processing unit (700) need to performs a simple conversion, of course, the conversion can also be done in any one of said processes.

In said implementation, there is no graphic adapter integrated in the sub-mainboard A generally, and the sub-mainboard B has a integrated graphic adapter, in which case, the output interface of the graphic adapter of the sub-mainboard B may be directly connected to the sub display interface, for example, sub display interface 2 (40), of the switching unit for sharing interface (710) through the PCB lines, the add-on graphic adapter of the mainboard A can be transferred to the sub display interface, for example, sub display interface 1 (40), of the switching unit for sharing interface (710) through a set of wires.

In other words, the integrated interfaces of the motherboard can be directly connected to the switching unit for sharing interface (710), and the interface of the add-on card is connected to the switching unit for sharing interface (710) by transferring-wires.

The relative settings can be adjusted in the BIOS configuration options, for example: user can choose the switching range of the shared interfaces, and may permit or prohibit the switching of certain shared interface.

Finally, the auxiliary storage with virtual dividing function and the method for virtual dividing the storage space of the auxiliary storage referred by this invention, if the reader can not get sufficient information within the scope of this manual, please refer to relative inventions (such as: the invention of China 00114264.X, or the application of China: 200410087209).

I claim:

1. A method of virtual dividing of data processing system, for virtual dividing a data processing system into a plurality of data processing systems, characterized in that: said virtual sub data processing systems can have their own operating systems or applications; said virtual sub data processing systems share the original data processing system resources by time-division; any time, at most, only one of the virtual sub data processing systems that share the same processor module is in the running state; user chooses the current running virtual sub data processing system by the switching device, the switching can be online switching or offline switching.

2. The method according to claim 1, characterized by further comprising means for making security isolation to the auxiliary storage(s) of the different virtual sub data processing systems, said means can be one of or some of or a combination of following means: (a) set up a plurality of physical independent auxiliary storages, make the different virtual sub data processing systems use the different physical independent auxiliary storages; (b) virtual dividing the storage space of single auxiliary storage, make the different virtual sub data processing systems use the different virtual sub storages of said auxiliary storage; (c)make read or write protection to the auxiliary storage space of the non-working state virtual sub data processing system; (d) make access deny to the auxiliary storage(s) that the current running virtual sub data processing system does not need; (e) make read or write protection to the auxiliary storage space(s) that the current running virtual sub data processing system does not need;

3. A switching method, for online switching between a plurality of virtual sub data processing systems that share the same processor module, said method comprises the following steps: (a) user sends the virtual sub data processing system swap request to the switching device; (b) the switching device sends the system swap out signal to the current running virtual sub data processing system; (c) the current running virtual sub data processing system saves its work spot; (d) the switching device sets up the resources for the next running virtual sub data processing system and sends out the system swap in signal; (e) the next running virtual sub data processing system takes over the control, restores the work spot saved previously, or the next running virtual sub data processing system takes over the control, performs boot or reboot or reset or user-defined boot;

4. A method of saving/restoring work spot, said method of saving work spot comprises the following steps: (a) the OS (Operating System) sends the “save work spot” notice to the running tasks; (b) the running tasks clean up their work spaces and resources; (c) the OS cleans up its work space(s) and resource(s); (d) save the basic system information which is enough to reconstruct the current working environment; (e) save the states of all the devices used by the OS; said method of restoring work spot comprises the following steps: (a) load the states of all the devices used by the OS at that time, which saved in “saving work spot” previously, and set up those device states; (b) load all the basic system information which is enough to reconstruct the working environment of that time, that saved in “saving work spot” previously, and reconstruct the working environment of that time; (c) the OS (Operating System) restores its work space(s) and resource(s); (d) the OS sends the “restore work spot” notice to all the running tasks; (e)the running tasks restore their work spaces and resources;

5. A data processing system, characterized by comprising: at least two or more sub data processing systems and a switching device (600); each of said sub data processing systems can be a sub data processing system with independent physical processor module, or can be a virtual sub data processing system sharing processor module; the processor module(s) of said sub data processing systems is(are) in the same physical casing; all of or part of said sub data processing systems share at least a display device or a input device; said switching device (600) is used for selecting the current sub data processing system for user to use or operate; said switching can be online switching or offline switching.

6. The system according to claim 5, characterized in that: the firmware device, that is re-programmable and can get chance to run in the processor module, of said sub data processing system is all or part write protection, or the content of said firmware can be non-juggled checked.

7. The system according to any one of claim 5, characterized in that: said different sub data processing systems use different auxiliary storages, or use the different virtual sub-storages of same auxiliary storage;

8. A switching device (601), is used to support virtual dividing data processing system, characterized by comprising: an input interface of control (701), for receiving the signal of selecting from user, the interface can be mechanical or electronic, it can be wired or wireless, the signal can be encoded signal or direct selecting signal; a control unit (700), for controlling the switching between different virtual sub data processing systems according to user's selecting signal; an interface to host (703), for communicating with the data processing system, the interface can be any kind of generic or special interface; an output interface of control (702), for providing the required selecting signal to other device(s) in the switching process of virtual sub data processing systems, the interface can be mechanical or electronic, it can be wired or wireless, the signal can be encoded signal or direct selecting signal; said control unit (700) is connected with said input interface of control (701), said output interface of control (702) and said interface to host (703); said input interface of control (701), said output interface of control (702) and said interface to host (703) can partially or wholly share the same interface bus, can also use different interfaces respectively;

9. A multi-unit motherboard, comprising at least two or more non-virtual sub-motherboard modules, said sub-motherboard can be general motherboard, it can also be a sub-motherboard with capability of virtual dividing, said multi-unit motherboard is used to build a data-processing system with a plurality of sub data processing systems, characterized by further comprising a switching device (602), said switching device (602) is used to support the selecting and switching of sub data processing systems, comprising: an input interface of control (711), for receiving the signal of selecting from user, the interface can be mechanical or electronic, it can be wired or wireless, the signal can be encoded signal or direct selecting signal; a switching unit for sharing interface (710), for switching the interface(s), which share the same device or same interface port, according to user's selecting signal; said switched interface can be the interface provided by the motherboard, it can also be the interface provided by the add-on card of the motherboard, said interface can be any kind of wired or wireless interface; said switching unit for sharing interface, having at least one shared display interface or one shared input device interface;

10. The motherboard according to claim 9, characterized by further an output interface of control (712), for providing the signal of selecting to other sub-motherboard module(s) or device(s) in the switching process of sub data processing systems, the interface can be mechanical or electronic, it can be wired or wireless, the signal can be encoded signal or direct selecting signal; said output interface of control (712) and said input interface of control (711) can share the same interface bus, can also use different interfaces respectively.
